(19) United States
(12) Patent Application Publication
(10) Pub. No.: US 2012/0092456 A1
(43) Pub. Date: Apr. 19, 2012

(54) VIDEO SIGNAL PROCESSING DEVICE, VIDEO SIGNAL PROCESSING METHOD, AND COMPUTER PROGRAM

(75) Inventor: Toshiya AKIBA, Kanagawa (JP)

(73) Assignee: Sony Corporation, Tokyo (JP)

(21) Appl. No.: 13/235,801

(22) Filed: Sep. 19, 2011

(30) Foreign Application Priority Data
Oct. 13, 2010 (JP) 2010-230692

(51) Int. Cl. H04N 13/02

(52) U.S. Cl. 348/46; 348/E13.074

(57) ABSTRACT

A video signal processing device which includes, a stereoscopic image input unit which alternately inputs a video frame for a left eye and a video frame for a right eye, in a time sharing manner; a plane memory which maintains graphic data which overlaps with the video frame; a read phase addition unit which gives a phase difference when reading the graphic data from the plane memory at the time of displaying the video frame for the left eye and the video frame for the right eye; and a video overlapping unit which overlaps each graphic data of which a read phase is provided with a difference, with each of the video frame for the left eye and the video frame for the right eye.

### BACKGROUND

The present disclosure relates to an image signal processing device, an image signal processing method and a computer program which process a stereoscopic image including video signals for the left eye and right eye. Particularly, the disclosure relates to an image signal processing device, an image signal processing method, and a computer program thereof in which a graphic display such as a character or a figure is overlapped with the stereoscopic images.

In the related art, it was possible to present a stereoscopic image which is three-dimensionally shown to a viewer by displaying a video with parallax in both left and right eye. As a method of presenting the stereoscopic image, there is provided a method which allows the viewer to wear glasses with special optical characteristics, and presents an image in which binocular parallax is given.

For example, a time sharing stereoscopic image display system is formed of a combination of a display device which displays a plurality of images which is different from each other, in a time sharing manner, and shutter glasses worn by a viewer of a video. The display device alternately displays a video for a left eye and a video for a right eye with binocular parallax in a very short cycle, on a screen. Meanwhile, the shutter glasses which are worn by the viewer include a shutter mechanism which is formed of respective liquid crystal lenses for the left eye and the right eye. The shutter glasses have a configuration in which a left eye portion of the shutter glasses allows light to permeate while a video for the left eye is displayed, and a right eye portion thereof shields the light. In addition, the right eye portion of the shutter glasses allows light to permeate while a video for the right eye is displayed, and the left eye portion thereof shields the light (for example, refer to Japanese Unexamined Patent Application Publication No. 9-138384, Japanese Unexamined Patent Application Publication No. 2000-36969, and Japanese Unexamined Patent Application Publication No. 2003-45343). That is, it is possible to present a stereoscopic image to the viewer by displaying videos for the left eye portion and the right eye in a time sharing manner, using the display device, and by the shutter glasses which select images in synchronization with display switching of the display device, using the shutter mechanism.

On the other hand, a technology which displays graphics of OSD (On Screen Display) or the like such as a character or a figure, by overlapping with the original video, is provided.

It is possible to view the graphic data such as the character or the figure three-dimensionally, similarly to the stereoscopic image, if there is binocular parallax between the display for the left eye and the display for the right eye. If the OSD information is overlapped with the stereoscopic image by adding an appropriate depth, in consideration of an arranging position in a depth direction, it is possible to further reduce eye fatigue which is caused when viewing OSD information and the stereoscopic image (for example, refer to Japanese Unexamined Patent Application Publication No. 2009-135686).

For example, an independent OSD plane is provided respectively for the left eye and the right eye; a phase difference corresponding to each depth, is given to objects which are drawn for the left eye and the right eye, to be written in the corresponding OSD plane; and the OSD plane for the left eye is overlapped with the video for the left eye, and the OSD plane for the right eye is overlapped with the video for the right eye, to be displayed in a time sharing manner, thereby it is possible to view the character and the figure three-dimensionally along with the video.

However, it is necessary to draw a set of OSD information for left eye and right eye, in order to display the character and figure three-dimensionally, using the above-described method. Accordingly, it is desired to strengthen the drawing ability of a drawing engine, because a double drawing processing is necessary, compared to a case where the OSD display is performed two-dimensionally. In addition, since separate OSD planes for left eye and right eye (that is, for two screens) are respectively necessary, double the memory area is used, compared to a case where the OSD display is performed two-dimensionally, whereby the cost of the device is doubled.

### SUMMARY

It is desirable to provide an excellent video signal processing device, video signal processing method, and a computer program which can display graphic data such as a character or a figure, with a suitable depth, to be overlapped with stereoscopic image including a video signal for the left eye and a video signal for the right eye.

It is further desirable to provide an excellent video signal processing device and video signal processing method, and a computer program which can display graphic data with a suitable depth to be overlapped with the stereoscopic image, with small processing load and in a memory saving manner.

According to an embodiment of the disclosure, there is provided a video signal processing device including: a stereoscopic image input unit which alternately inputs a video frame for the left eye and a video frame for the right eye in a time sharing manner; a plane memory for maintaining graphic data which overlaps with a video frame; a read phase addition unit which gives a phase difference, when reading graphic data from the plane memory at the time of displaying a video frame for a left eye and at the time of displaying a video frame for a right eye; and a video overlapping unit which overlaps each graphic data of which a read phase is differentiated, with the video frame for a left eye and the video frame for a right eye, respectively.

In the video signal processing device, the read phase addition unit may be configured to give a difference to the read phase in a unit of a drawn object which is drawn in the plane memory, or a bitmap unit.

In the video signal processing device, the read phase addition unit may be configured by a depth information holding unit which maintains depth information in a unit of a drawn object which is drawn in the plane memory, or a bitmap unit, and a binocular parallax addition unit which maintains graphic data which is read at each display timing of the video frame for the left eye and the video frame for the right eye and gives the phase difference at the time of displaying the video frame for the left eye and at the time of displaying the video frame for the right eye, by setting a delay amount, on the basis of the depth information which is maintained in the depth information holding unit.

In the video signal processing device, the video signal processing device may further include a graphic data expansion and contraction unit which expands or contracts graphic data which is read at each display timing of the video frame for the left eye and the video frame for the right eye, on the basis of the depth information which is maintained in the depth information holding unit.

According to still another embodiment of the disclosure, there is provided a video signal processing device includes, a stereoscopic image input unit which alternately inputs the video frame for the left eye and the video frame for the right eye, in a time sharing manner; a plane memory which is configured by one or more windows for each drawn object which overlaps with a video frame; a depth information holding unit which maintains depth information for each window; a read phase addition unit which changes a phase difference when reading a window at the time of displaying the video frame for the left eye and at the time of displaying the video frame for the right eye, on the basis of the depth information which is maintained in the depth information holding unit; and a video overlapping unit which overlaps each window of which the read phase is differentiated, with each of the video frame for the left eye and the video frame for the right eye.

The video signal processing device may further include a window expansion and contraction unit which expands or contracts each window, on the basis of the depth information which is maintained in the depth information holding unit.

According to still another embodiment of the disclosure, there is provided a video signal processing method which includes, maintaining graphic data which overlaps with a video frame, to a plane memory; reading graphic data from the plane memory by giving a difference to a read phase, at the time of displaying a video frame for a left eye and at the time of displaying a video frame for a right eye; and overlapping each graphic data of which the read phase is differentiated, with each of the video frame for the left eye and the video frame for the right eye.

According to still another embodiment of the disclosure, there is provided a video signal processing method includes, maintaining each drawn object which overlaps with a video frame, to a window to which a plane memory corresponds; reading window from the plane memory by giving a difference to a read phase, on the basis of a depth information at the time of displaying a video frame for a left eye and at the time of displaying a video frame for a right eye; and overlapping each window of which the read phase is differentiated, with each of the video frame for the left eye and the video frame for the right eye.

According to still another embodiment of the disclosure, there is provided a computer program which is described to be read by a computer, in order to execute a processing of a video signal on the computer, which allows the computer to function as, a stereoscopic image input unit which alternately inputs a video frame for a left eye and a video frame for a right eye, in a time sharing manner; a plane memory which maintains graphic data which overlaps with a video frame; a read phase addition unit which gives a phase difference when reading graphic data from the plane memory, at the time of displaying a video frame for a left eye and at the time of displaying a video frame for a right eye; and a video overlapping unit which overlaps each graphic data of which the read phase is differentiated, with each of the video frame for the left eye and the video frame for the right eye.

According to still another embodiment of the disclosure, there is provided a computer program which is described to be read by a computer, in order to execute a processing of a video signal on the computer, which allows the computer to function as, a stereoscopic image input unit which alternately inputs a video frame for left eye and a video frame for right eye, in a time sharing manner; a plane memory which is configured by one or more windows for each drawn object which overlaps with a video frame; a depth information holding unit which maintains a depth information of each window; a read phase addition unit which changes a phase difference when reading a window from the plane memory, at the time of displaying a video frame for a left eye and at the time of displaying a video frame for a right eye, on the basis of depth information which is maintained in the depth information holding unit; and a video overlapping unit which overlaps each window of which the read phase is differentiated, with each of the video frame for the left eye and the video frame for the right eye.

The computer program according to the embodiments of the disclosure means a computer program which is described to be readable by the computer, so as to realize a predetermined processing by the computer. In other words, the computer program according to the embodiments of the disclosure is installed to the computer to execute a cooperative operation by the computer, thereby obtaining the same operational effect as that of the video signal processing device according to the embodiments of the disclosure.

According to the embodiments of the disclosure, it is possible to provide an excellent video signal processing device, a video signal processing method, and a computer program which can display graphic data with a suitable depth to be overlapped with the stereoscopic image, with a small process load and in a memory saving manner.

According to the embodiments of the disclosure, since one plane memory is shared for both the left eye and the right eye without using separate plane memory for both the left eye and the right eye, in order to maintain graphic data, a load of a drawing process of the graphic data becomes low, and it is possible to make the plane memory which maintains the graphic data have a small capacity. The plane memory may have a normal size which is the same size used when displaying a two-dimensional video.

According to the embodiments of the disclosure, it is possible to make the video frame for the left eye and the video frame for the right eye to be overlapped with each other by applying a suitable depth to the graphic data, by providing a phase difference when reading from the one plane memory which is shared by the video frame for the left eye and the video frame for the right eye. Since the graphic data can be seen three-dimensionally, along with the stereoscopic image, it is possible to reduce eye fatigue of viewers.

According to the embodiments of the disclosure, by providing a phase difference at reading timing from a plane, it is possible to emphasize a sense of depth (distance) in vision, by expanding or contracting graphic data which overlaps with video frames for the left eye and the right eye, on the basis of depth information.

Further, advantages of the disclosure will be clarified by detailed descriptions based on the embodiment of the disclosure to be described later or the accompanying drawings.

### BRIEF DESCRIPTION OF THE DRAWINGS

FIGS. 1A and 1B are diagrams which schematically shows a configuration example of a video display system;

FIG. 2 is a diagram which shows an internal configuration example of a display device;

FIG. 3 is a diagram which shows an internal configuration example of shutter glasses;

FIG. 4 is a diagram which shows a control operation of shutter glasses in an L subframe time period;

FIG. 5 is a diagram which shows a control operation of shutter glasses in an R subframe time period;

FIG. 6A is a diagram which schematically shows a functional configuration for overlapping OSD information to a stereoscopic image;

FIG. 6B is a diagram which schematically shows a functional configuration for expanding or contracting OSD information which overlaps with the stereoscopic image, on the basis of a depth;

FIG. 7 is a diagram which shows a manner of adding binocular parallax to the OSD information which overlaps with the stereoscopic image;

FIG. 8A is a diagram which schematically shows the other functional configuration example for overlapping the OSD information with the stereoscopic image; and

FIG. 8B is a diagram which schematically shows a functional configuration for expanding or contracting OSD information which overlaps with the stereoscopic image, on the basis of depth.

### DETAILED DESCRIPTION OF EMBODIMENTS

The embodiment according to the disclosure will be described with reference to accompanying drawings.

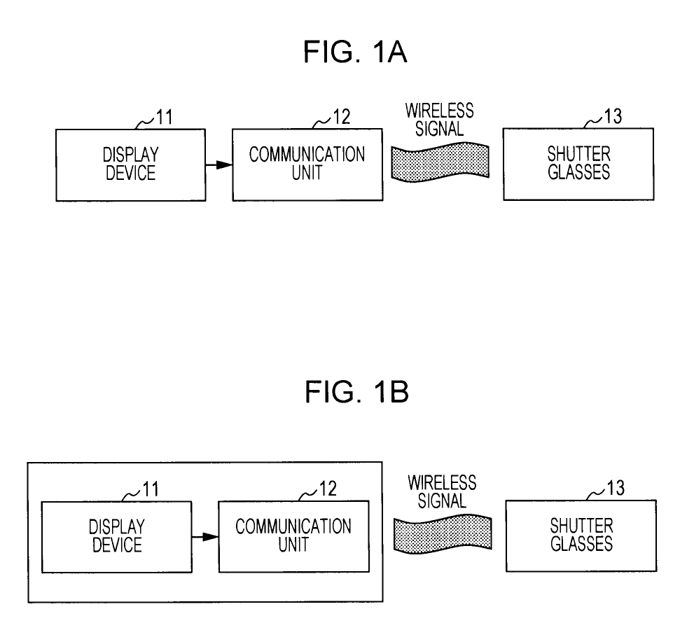

FIG. 1 schematically shows a configuration example of a video display system. The video display system is formed of a combination of a display device 11 which can display images three dimensionally (stereoscopically) and shutter glasses 13 having a shutter mechanism for the left eye and the right eye, respectively. In an example shown in FIG. 1A, a wireless signal is transmitted and received between a communication unit 12 which is connected to the display device 11 through an external terminal, and shutter glasses 13. In addition, in an example shown in FIG. 1B, a wireless signal is transmitted and received between a communication unit 12 which is built in a main body of the display device 11 and shutter glasses 13.

In many cases, infrared transmission is used as a communication unit between the display device and the shutter glasses; however, in this embodiment, a wireless network using radio communication, such as IEEE802.15.4, or the like, is used. In the system configuration example shown in FIG. 1, the display device 11 and the shutter glasses 13 perform one-to-one communication. However, it is possible to accommodate a plurality of shutter glasses which operate as a terminal station, respectively, by allowing the communication unit 12 of the display device 11 to operate as an access point.

A display device which is used for displaying a stereoscopic image is not limited to a specified type. For example, it is possible to adopt a plasma display panel (PDP), a liquid crystal display (LCD), and an electroluminescence (EL) panel, in addition to a CRT (Cathode Ray Tube) display in the related art. Hereinafter, the display device 11 is set to a liquid crystal display.

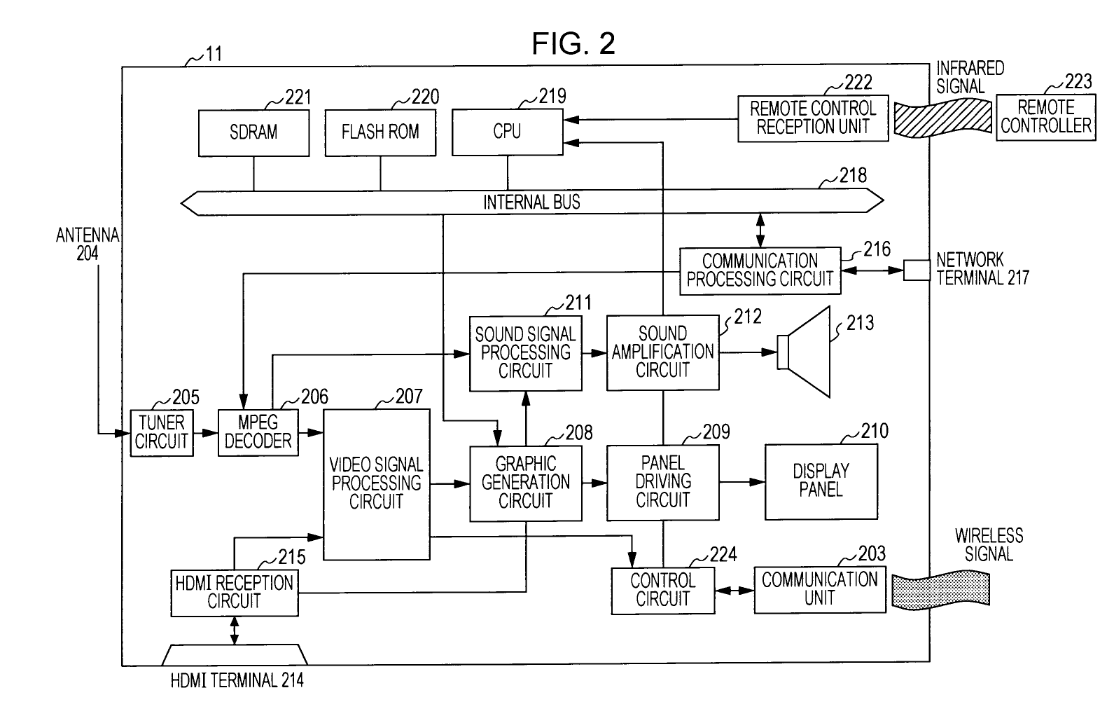

An internal configuration example of the display device 11 is illustrated in FIG. 2. However, it is a display device in which a communication unit of a wireless network is built in the main body, in the figure (refer to FIG. 1B). Hereinafter, each unit will be described.

It is possible to receive a broadcast wave which broadcasts a stereopsis program using an antenna 204. A tuner circuit 205 selects a desired stream when the broadcast wave is input from the antenna 204. An MPEG decoder 206 extracts a video signal and a sound signal from the selected stream which is selected by the tuner circuit 205.

In addition, there is a case where stereopsis contents are input from an external source device (not shown) which is connected to an HDMI (High-Definition Multimedia Interface) terminal 214 which is a digital interface, and a case where the stereopsis contents are received through the Internet, as a means of acquiring a video signal other than the broadcast wave.

An HDMI reception circuit 215 divides the signal which is input from the external source device connected to the HDMI terminal 214, to a video signal processing circuit 207 and a sound signal processing circuit 211. In addition, a reception signal from a network terminal 217 is input to the MPEG decoder 206 through a communication processing circuit 216 such as Ethernet (trade mark) interface. The MPEG decoder 206 extracts the video signal and the sound signal from the reception signal.

The video signal is input to the video signal processing circuit 207, and necessary signal processing is performed. The signal processing performed by the video signal processing circuit 207 includes, for example, an image correction processing such as color-point calibration or intensity reduction. A panel driving circuit 209 controls a driving timing of a gate driver and a data driver (both are not shown), and supplies a video signal which is supplied from the video signal processing circuit 207, to the data driver. The panel driving circuit 209 may perform overdrive processing on the video signal.

A graphic processing circuit 208 generates OSD information which is formed of a character or a figure, when necessary, and overlaps the information with the video signal which is output from the video signal processing circuit 207. The graphic processing circuit 208 generates OSD information, for example, according to a drawing instruction received from a CPU 219 through an internal bus 218. Alternatively, the OSD information is transmitted to the graphic processing circuit 208 from the CPU 219, through the internal bus 218. The graphic processing circuit 208 includes an OSD plane for temporarily maintaining the OSD information to be drawn; reads the OSD information in synchronization with the video signal; performs overlapping processing; and outputs to the panel driving circuit 209 which is in the next stage, when displaying an OSD display. In this embodiment, an appropriate depth is given to the OSD information which is overlapped with and displayed to a stereopsis signal, when displaying and outputting the stereopsis signal, however, details of the process will be described later.

In addition, the sound signal is input to a sound signal processing circuit 211, and, after necessary signal processing is performed thereon, is amplified to a desired sound level in a sound amplification circuit 212, and then drives a speaker 213.

The video signal processing circuit 207 processes the video signal, generates a frame switching signal which is necessary for a switching control of shutters of the shutter glasses, at the same time, and inputs the signals to a control circuit 224. The control circuit 224 generates an opening control signal which instructs a switching timing of left and right shutters of the shutter glasses, on the basis of the timing of the input frame switching signal. The opening control signal is wirelessly transmitted to the shutter glasses from the communication unit 203 through the radio communication.

A control code which is transmitted using an infrared ray is received by a remote control reception unit 222, when a user operates the display device 11 by performing a remote control with a remote controller 223. In an example shown in FIG. 2, an infrared communication-type is adopted for remote control; however, the communication unit 203 may be also used in remote controlling.

In order to control the entire display device 11, a circuit component, such as the CPU 219, a Flash ROM 220, a DRAM 21, or the like is installed. The control code which was received in the remote control reception unit 222 (or the communication unit 203) is transmitted to the CPU 219 through the internal bus 218. The CPU 219 controls the operation of the display device 11 by reading the control code. In addition, glasses information which is received in the communication unit 213 is input to the CPU 219 through the control circuit 224. The CPU 219 stores the glasses information along with calculated information, in the Flash ROM 220.

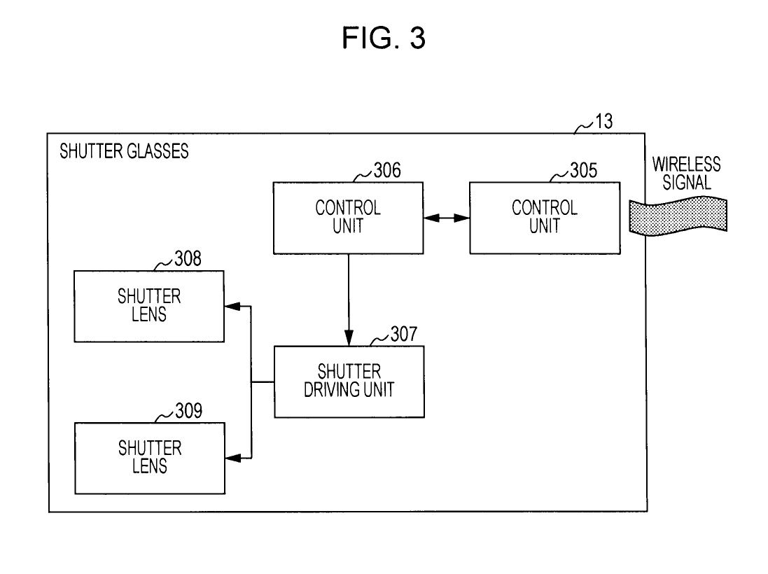

In FIG. 3, an internal configuration example of the shutter glasses 13 is illustrated. The shutter glasses 13 include a communication unit 305 which transmits and receives a wireless signal, using the radio communication to and from the display device 11, a control unit 306, a storage unit 310 which stores glasses information or the other data, a shutter 308 for a left eye and a shutter 309 for a right eye which are formed of a liquid crystal material, respectively, and a shutter driving circuit 307.

The wireless signal which is transmitted to the shutter glasses 13 from the display device 11 is, for example, the opening control signal which instructs the switching timing of the left and right shutters of the shutter glasses. The communication unit 305 inputs the opening control signal to the control unit 306, when receiving the opening control signal. The control unit 306 reads the opening control signal, discriminates the switching timing of the left and right shutters, 308 and 309, and controls the switching operation of each left and right shutter 308 and 309, through a shutter driving circuit 307, on the basis of the discriminating result.

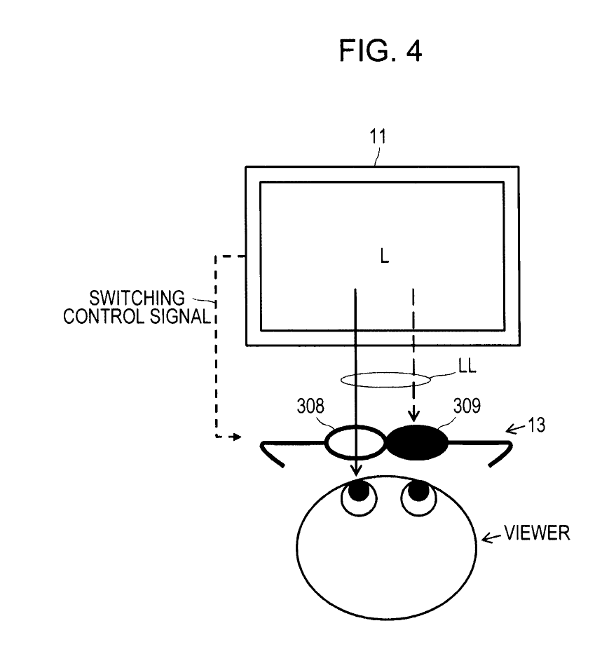

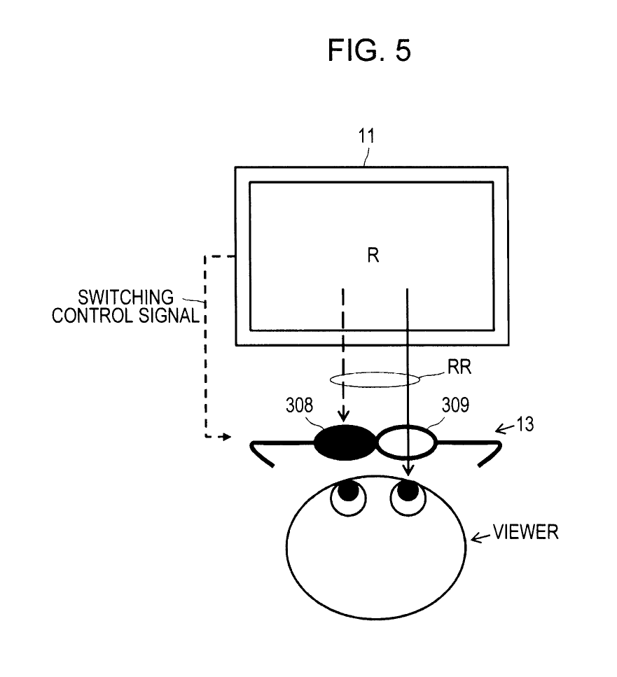

In FIG. 4, a control operation of the shutter glasses 13 in an L subframe time period, is illustrated. As shown in the figure, in the L subframe time period, the shutter for a left eye 308 is set to an open state and the shutter for a right eye 309 is set to a closed state, according to the switching control signal which is wirelessly transmitted from the communication unit 203 on the display device 11 side, and display light LL based on an image L for a left eye, reaches only the left eye of a viewer. In addition, in FIG. 5, a control operation of the shutter glasses 13 in an R subframe time period, is illustrated. As shown in the figure, in the R subframe time period, the shutter for a right eye 309 is set to an open state and the shutter for a left eye 308 is set to a closed state, according to the switching control signal from the display device 11 side, and display light RR based on an image R for a right eye, reaches only the right eye of the viewer.

When displaying and outputting the stereoscopic image in the display device 11, it is possible to reduce eye fatigue caused when viewing the OSD information and the stereoscopic image, by also giving a suitable depth to the OSD information such as a character figure which is displayed in an overlapping manner. However, when drawing independent OSD information for the left and the right eye, respectively, the drawing processing is performed twice, in spite of having the same contents. In addition, it is necessary to use two OSD planes for writing the contents, thereby increasing a load for drawing processing, and consuming a memory resource.

On the other hand, the inventor proposes an embodiment in which the stereoscopic OSD information is drawn with a small processing load, an OSD plane with a small capacity is used, the OSD information with depth is overlapped with the stereoscopic image, and displayed. In this embodiment, OSD information which is shared by the left eye and the right eye, is drawn on one OSD plane, without having an independent OSD plane for the left eye and the right eye. In addition, when overlapping and displaying the OSD information to the stereoscopic image, a suitable depth is given to the OSD information, by delaying timing for reading the OSD information from the OSD plane. A phase difference is provided to timing for reading the OSD information from the OSD plane, by a delaying amount which corresponds to the depth, that is, the binocular parallax between the image for the left eye and the image for the right eye, at the time of displaying a video frame for the left eye and at the time of displaying a video frame for the right eye. Even though the OSD information has the same coordinate position on the OSD plane, since a horizontal display position is displaced by a phase difference of the reading timing, in the video frame for the left eye and the video frame for the right eye, this is viewed as binocular parallax by the viewer, accordingly, it is possible to realize stereopsis of the OSD information.

Overlapping processing of the OSD information with the video is performed in the graphic processing circuit 208, in the display device 11 shown in FIG. 2 (described before). Accordingly, when displaying a stereoscopic image, processing for giving the depth to the OSD information may be performed in the graphic processing circuit 208.

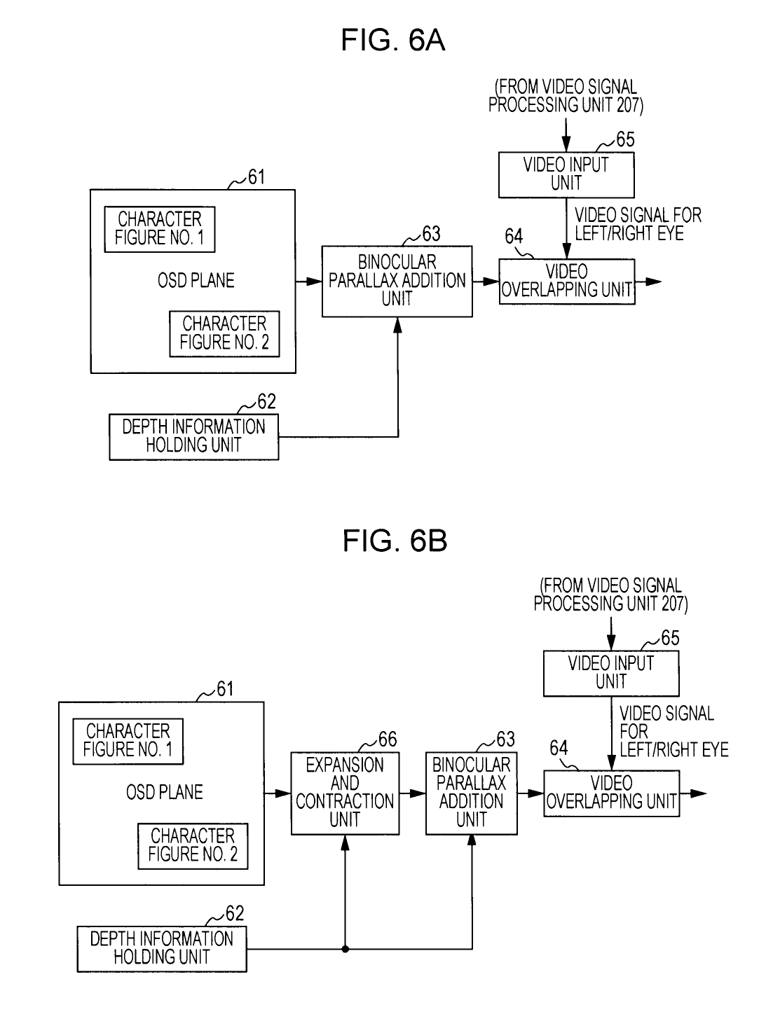

A functional configuration for overlapping the OSD information with the stereoscopic image, is schematically illustrated in FIG. 6A. The functional configuration in the drawing, is mounted, for example, in the graphic processing circuit 208, however, the point of the disclosure is not limited to a specific example in mounting.

An OSD plane 61 is a plane memory which temporarily maintains the OSD information which overlaps with the video frame. In the embodiment, the OSD plane 61 which is formed of a single plane memory, is shared by the left eye and the right eye, when displaying the stereoscopic image by displaying the video frame for the left eye and the video frame for the right eye, in a time sharing manner. That is, one plane of the plane memory for the OSD may have the same size as one plane when displaying a normal two-dimensional image.

The OSD information is formed of a drawn object such as a character or a figure. In an example shown in FIG. 6, two drawn objects of a character figure No. 1 and a character figure No. 2 are configured to overlap with the video frame, and to be drawn at each corresponding coordinate position on the OSD plane 61.

The graphic processing circuit 208 generates an object such as the character or the figure, according to the drawing instruction which is received from the CPU 219 through the internal bus 218, and performs drawing at the corresponding position of the OSD plane 61. Alternatively, the graphic processing circuit 208 draws the OSD information which is transmitted from the CPU 219 through the internal bus 218, in the OSD plane 61.

When displaying the stereoscopic image, the OSD information is read from the OSD plane 61 in synchronization with each display timing of the video frame for the left eye and the video frame for the right eye.

A depth information holding unit 62 maintains depth information which is related to the OSD information and maintained in the OSD plane 61, by linking. The depth information holding unit 62 can maintain the depth information in a drawn object unit which is included in the OSD information, or in a bitmap unit. In the following description, for simplicity, the depth information holding unit is presumed to maintain the depth information in a drawn object unit (in an example shown in FIG. 6, for each of the character figure No. 1 and the character figure No. 2). The depth information holding unit 62 is presumed to maintain depth information d_{L} in the video frame for the left eye and depth information d_{R} in the video frame for the right eye for each drawn object, for example, in a data structure shown in a table below.

TABLE 1

| | Depth information | Depth information |
|---|---|---|
| | d_{L} for left eye | d_{R} for right eye |
| Drawn object ID | video | video |
| No. 1 | . . . | . . . |
| . . . | . . . | . . . |

A binocular parallax addition unit 63 adds binocular parallax to the OSD information read from the OSD plane 61 according to each of display timing of the video frame for the left eye and the video frame for the right eye, on the basis of the depth information which is maintained in the depth information holding unit. The binocular parallax is added to the OSD information by providing a phase difference by a delay amount based on the depth information, when the OSD information is read from the OSD plane 61 in synchronization with each of display timing of the video frame for the left eye and the video frame for the right eye. For example, when depth information of each a video frame for a left eye and a video frame for a right eye of a certain drawn object is set to d_{L} and d_{R}, a phase difference corresponding to D=d_{L}−d_{R} is provided between the read OSD information in synchronization with each display timing of the video frame for the left eye and the video frame for the right eye.

It is possible to configure the binocular parallax addition unit 63, for example, with a FIFO memory. Drawn object data which is read from the OSD plane 61 in synchronization with each display timing of the left and right video frames, is temporarily stored in the FIFO memory. In addition, it is possible to give the phase difference to OSD information for each of the left and right video frames, if a delay amount is set to the FIFO memory on the basis of the depth information (d_{L} and d_{R}) which is maintained in the depth information holding unit 62.

A video input unit 65 inputs a video signal from an output stage of the video signal processing circuit 207. A video overlapping unit 64 overlaps an input video signal and OSD information signal which is read from the OSD plane 61 with each other. A delay amount corresponding to D=d_{L}−d_{R} is provided between the video frames for the left eye and the right eye, at display timing of the OSD information, using the binocular parallax addition unit 63, when displaying the stereoscopic image by alternately displaying the video frame for the left eye and the video frame for the right eye, in a time sharing manner. For this reason, a phase difference is present at a display position in the frame of the OSD information between the video frame for the left eye and the video frame for the right eye, after performing overlapping in the video overlapping unit 64. Therefore, it is viewed as binocular parallax by the viewer, and the OSD information is viewed three-dimensionally along with the stereoscopic image.

In addition, it is possible to emphasize a sense of depth (distance) in vision, by expanding or contracting the OSD information, on the basis of the depth, as well as providing the phase difference to the OSD information which overlaps with each of the video frames for the left eye and the right eye.

A functional configuration for expanding and contracting the OSD information which overlaps with the stereoscopic image, on the basis of the depth, is schematically illustrated in FIG. 6B, as a modified example of FIG. 6A. A main difference from FIG. 6A is that FIG. 6B further includes an expansion and contraction unit 86. The expansion and contraction unit 86 expands or contracts data of the drawn object which is read at each of display timing of the video frame for the left eye and the video frame for the right eye, on the basis of the depth information which is maintained in the depth information holding unit 62. As a result, it is possible to emphasize the sense of depth (distance) in vision, since the OSD information which is displayed in the video frame for the left eye and the video frame for the right eye, is displayed with a size corresponding to the depth. In the example shown in FIG. 6B, it is configured that the drawn object is expanded or contracted in the expansion and contraction unit 86, and then is provided with the phase difference in the binocular parallax addition unit 63. However, it may be configured such that each of the video frames for the left eye and the right eye is provided with the phase difference in the binocular parallax addition unit 63, and then the drawn object is expanded or contracted in the expansion and contraction unit 86.

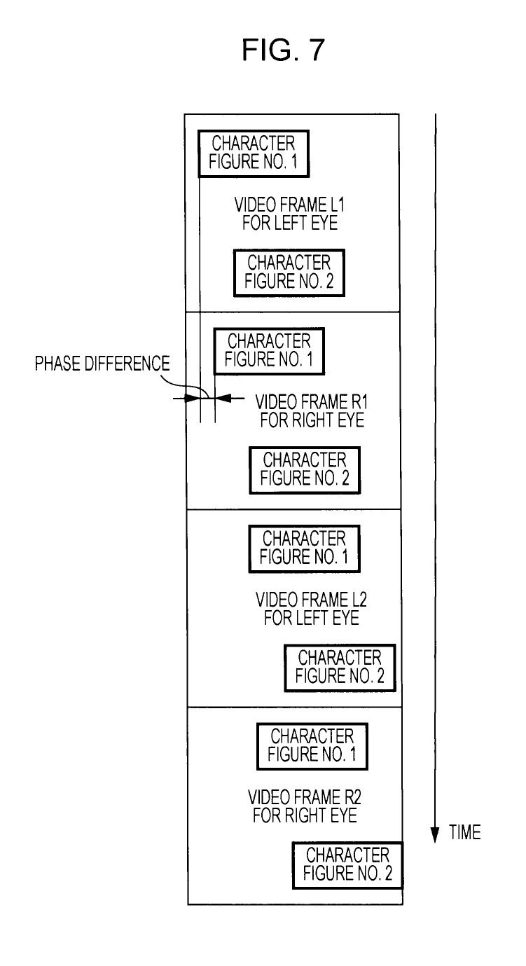

A manner of giving binocular parallax to the OSD information which overlaps with the stereoscopic image, is illustrated in FIG. 7. One frame of the stereoscopic image is formed of a set of a video frame L for the left eye and a video frame R for the right eye, which is displayed in a time sharing manner. A phase difference based on each item of depth information is set with respect to the character figure No. 1 and the character figure No. 2 which are read from the OSD plane 61, at the time of displaying the video frames for the left eye and the right eye. For this reason, there is a phase difference at a display position in the frames of the character figure No. 1 and the character figure No. 2 which are respectively overlapped with the video frames for the left eye and the right eye. Accordingly, this phase difference is viewed as binocular parallax by the viewer, and the character figure No. 1 and the character figure No. 2 are three-dimensionally viewed, similarly to the stereoscopic image.

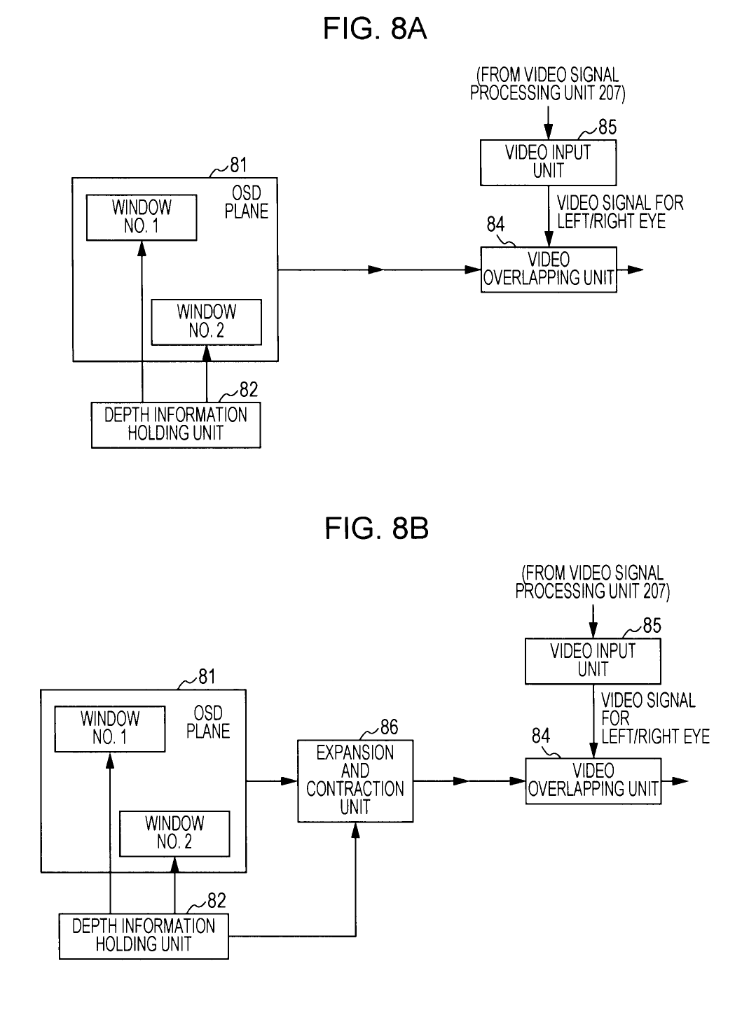

The other functional configuration example for overlapping the OSD information with the stereoscopic image, is schematically illustrated in FIG. 8A. It is configured such that a single OSD plane 81 is shared by the video frames for the left eye and the right eye, similarly to the configuration example shown in FIG. 6. However, it is different from the example in FIG. 6 in that the OSD plane 81 is configured with one or more windows in a drawn object unit.

The OSD information is formed of one or more drawn objects such as the character figure, however, the window is configured in units of objects. Each window is a plane having a size and a position on the frame. Processing for giving binocular parallax or overlapping video frames for the left eye and the right eye, is performed in units of windows.

The character figure No. 1 and the character figure No. 2 shown in FIG. 6A correspond to the window No. 1 and the window No. 2 in FIG. 8A, respectively. Each window is a plane which has the original position and size on the frame.

When displaying the stereoscopic image, the OSD information is read from the OSD plane 81, in synchronization with each of the display timing of the video frame for the left eye and the video frame of the right eye.

A depth information holding unit 82 maintains depth information for each window which is maintained in the OSD plane 81, by linking.

The window is read from the OSD plane 81 in synchronization with each of the display timing of the video frame for the left eye and the video frame of the right eye; however, the read phase is changed for each of the video frames for the left eye and the right eye, on the basis of the depth information of the window.

As described above, the read window data is temporarily written in the FIFO memory, in synchronization with each of display timing of the video frames for the left eye and the right eye, and it is possible to change the read phase for each of the video frames for the left eye and the right eye, by setting a delay amount to the FIFO memory, on the basis of the depth information of the window.

A video signal input unit 85 inputs a video signal from the output stage of the video signal processing circuit 207. A video overlapping unit 84 overlaps the input video signal with each window which is read from the OSD plane 81. When displaying the stereoscopic image by alternately displaying the video frame for the left eye and the video frame for the right eye, in a time sharing manner, each window is provided with a difference in the read phase, on the basis of the depth information. For this reason, there is a phase difference at a display position in the frame of each window between the video frame for the left eye and the video frame for the right eye, after the overlapping in the video overlapping unit 84. This phase difference is viewed as binocular parallax by the viewer, and the OSD information is three-dimensionally viewed along with the stereoscopic image.

In addition, it is possible to emphasize a sense of depth (distance) in vision, by expanding or contracting the OSD information, on the basis of the depth, as well as providing the phase difference to the OSD information which overlaps with each of the video frames for the left eye and the right eye.

A functional configuration for expanding and contracting the OSD information which overlaps with the stereoscopic image, on the basis of the depth, is schematically illustrated in FIG. 8B, as a modified example of FIG. 8A. A main difference from FIG. 8A is that FIG. 8B further includes an expansion and contraction unit 86. The expansion and contraction unit 86 expands or contracts each of objects No. 1 and No. 2 which are read from the OSD plane 81, on the basis of each of the depth information which is maintained in the depth information holding unit 62. As a result, it is possible to emphasize the sense of depth (distance) in vision, since the OSD information which is displayed in the video frame for the left eye and the video frame for the right eye, is displayed with a size corresponding to the depth.

The present disclosure contains subject matter related to that disclosed in Japanese Priority Patent Application JP 2010-230692 filed in the Japan Patent Office on Oct. 13, 2010, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A video signal processing device comprising:
a stereoscopic image input unit which alternately inputs a video frame for a left eye and a video frame for a right eye, in a time sharing manner;
a plane memory which maintains graphic data which overlaps with the video frame;
a read phase addition unit which gives a phase difference when reading the graphic data from the plane memory at the time of displaying the video frame for the left eye and the video frame for the right eye; and
a video overlapping unit which overlaps each graphic data of which a read phase is provided with a difference, with each of the video frame for the left eye and the video frame for the right eye.

2. The video signal processing device according to claim 1,
wherein the read phase addition unit gives a difference to the read phase in a drawn object unit which is drawn in the plane memory, or in a bitmap unit.

3. The video signal processing device according to claim 1,
wherein the read phase addition unit includes:
a depth information holding unit which maintains depth information in a unit of drawn object which is drawn in the plane memory, or in a bitmap unit; and
a binocular parallax addition unit which maintains graphic data which is read at each display timing of the video frame for the left eye and the video frame for the right eye, sets a delay time amount, on the basis of the depth information which is maintained in the depth information holding unit, and gives a phase difference at the time of displaying a video frame for a left eye and at the time of displaying a video frame for a right eye.

4. The video signal processing device according to claim 3 further comprising:
a graphic data expansion and contraction unit which expands or contracts read graphic data at each display timing of the video frame for the left eye and the video frame for the right eye, on the basis of the depth information which is maintained in the depth information holding unit.

5. A video signal processing device comprising:
a stereoscopic image input unit which alternately inputs a video frame for a left eye and a video frame for a right eye, in a time sharing manner;
a plane memory which is configured by one or more windows for each drawn object which overlaps with a video frame;
a depth information holding unit which maintains depth information of each window;
a read phase addition unit which changes a phase difference when reading a window from the plane memory, at the time of displaying a video frame for a left eye and at the time of displaying a video frame for a right eye, on the basis of the depth information which is maintained in the depth information holding unit; and
a video overlapping unit which overlaps each window of which a read phase is differentiated, with the video frame for the left eye and the video frame for the right eye, respectively.

6. The video signal processing device according to claim 3 further comprising:
a window expanding and contracting unit which expands or contracts each window, on the basis of the depth information which is maintained in the depth information holding unit.

7. A video signal processing method comprising:
maintaining graphic data which overlaps with a video frame in a plane memory;
reading the graphic data from the plane memory by differentiating a read phase, at the time of displaying a video frame for a left eye and at the time of displaying a video frame for a right eye; and
overlapping graphic data of which the read phase is differentiated, with the video frame for the left eye and the video frame for the right eye, respectively.

8. A video signal processing method comprising:
maintaining each drawn object which overlaps with a video frame in a corresponding window of a plane memory;
reading the window from the plane memory by differentiating a read phase, on the basis of depth information, at the time of displaying a video frame for a left eye and at the time of displaying a video frame for a right eye; and
overlapping each window of which the read phase is differentiated, with the video frame for the left eye and the video frame for the right eye, respectively.

9. A computer program which is described to be read by a computer so that a video signal processing is performed on the computer,
wherein the computer program allows the computer to function as,
a stereoscopic image input unit which alternately inputs a video frame for a left eye and a video frame for a right eye, in a time sharing manner;
a plane memory which maintains graphic data which overlaps with a video frame;
a read phase addition unit which gives a phase difference when reading graphic data from the plane memory at the time of displaying the video frame for the left eye and at the time of displaying the video frame for the right eye; and
a video overlapping unit which overlaps each graphic data of which a read phase is differentiated, with the video frame for the left eye and the video frame for the right eye, respectively.

10. A computer program which is described to be read by a computer so that a video signal processing is performed on the computer,
wherein the computer program allows the computer to function as,
a stereoscopic image input unit which alternately inputs a video frame for a left eye and a video frame for a right eye, in a time sharing manner;
a plane memory which is configured by one or more window for each drawn object which overlaps with a video frame;
a depth information holding unit which maintains depth information of each window;
a read phase addition unit which gives a phase difference when reading window from the plane memory at the time of displaying the video frame for the left eye and at the time of displaying the video frame for the right eye; and
a video overlapping unit which overlaps each window of which a read phase is differentiated, with the video frame for the left eye and the video frame for the right eye, respectively.
